(19) United States
(12) Patent Application Publication
(10) Pub. No.: US 2012/0136461 A1
(43) Pub. Date: May 31, 2012

(54) REMOTE MANAGEMENT SYSTEM, REMOTELY-MANAGED DEVICE, AND MEDIATION DEVICE

(76) Inventor: Jun SATOH, Tokyo (JP)

(21) Appl. No.: 13/295,588

(22) Filed: Nov. 14, 2011

(30) Foreign Application Priority Data
Nov. 30, 2010 (JP) 2010-266596

(51) Int. Cl. G05B 15/02

(52) U.S. Cl. 700/19

(57) ABSTRACT

A remote management system includes: a remotely-managed device; a mediation device; and a remote management device that remotely manages the remotely-managed device via the mediation device. The remotely-managed device includes: a first communication unit that transmits predetermined identification information held in the remotely-managed device to the remote management device, and receives an address of the mediation device from the remote management device as a response; a second communication unit that notifies the mediation device of information on the remotely-managed device using the address of the mediation device having been received from the remote management device; and a control unit that causes the first communication unit and the second communication unit to perform a series of communication processing each time the remotely-managed device is booted. The mediation device includes: a fourth communication unit that receives the information on the remotely-managed device notified by the remotely-managed device.

### CROSS-REFERENCE TO RELATED APPLICATIONS

The present application claims priority to and incorporates by reference the entire contents of Japanese Patent Application No. 2010-266596 filed in Japan on Nov. 30, 2010.

### BACKGROUND OF THE INVENTION

1. Field of the Invention

The present invention relates to a remote management system, a remotely-managed device, and a mediation device.

2. Description of the Related Art

Conventionally, there are remote management systems to manage various devices remotely. Such remote management systems include one in which a mediation device having, for example, a device search function, a device-list display function, and a device-status monitoring function is provided in a client network. The device search function here is a function of searching for a device to be monitored on the client network; the device-list display function is a function of displaying a list of devices found on the client network and status of these devices on a user interface of the mediation device for the purpose of managing the devices on the client side; the device-status monitoring function is a function of notifying a management device in the remote management system or an administrator of a status of a device if the status of the device meets a predetermined monitoring condition.

An example of the remote management system as described above is disclosed in Japanese Patent Application Laid-open No. 2003-323360. In Japanese Patent Application Laid-open No. 2003-323360, there is described the device search function, the device-list display function, and the device-status monitoring function of the mediation device, and, particularly, that for searching for an image forming apparatus, such as a multifunction peripheral (MFP) or a printer, on a local network, the mediation device actively operates and searches for an image forming apparatus on the local network, and updates a list of apparatuses to be monitored on the basis of a result of the search.

However, the conventional remote management system, such as an image-forming-apparatus management system disclosed in Japanese Patent Application Laid-open No. 2003-323360, works on a condition that a device to be monitored must be in a power-on status and also must be connected to the network so as to be detectable by the remote management system with the use of the device search function. Only if the condition is met, the device search function can search for a device to be monitored on the network. Therefore, the device search function can search, on the network, for an image forming apparatus such as an MFP or a printer that is used over a long time to meet the condition.

On the other hand, there is a request to add, for example, a projector as an object to be monitored in addition to an image forming apparatus such as an MFP or a printer. A device like a projector has utilization characteristics that “a network-connection time by keeping power-on is shorter” than an MFP or a printer, and such a projector can “be carried and used in a variety of places”. Therefore, the probability that the conventional device search function can search for a device such as a projector on the network is very low as compared with an MFP, a printer, or the like.

### SUMMARY OF THE INVENTION

It is an object of the present invention to at least partially solve the problems in the conventional technology.

According to an aspect of the present invention, there is provided a remote management system including: a remotely-managed device; a mediation device; and a remote management device that remotely manages the remotely-managed device via the mediation device. The remotely-managed device includes: a first communication unit that transmits predetermined identification information held in the remotely-managed device to the remote management device, and receives an address of the mediation device from the remote management device as a response; a second communication unit that notifies the mediation device of information on the remotely-managed device using the address of the mediation device that has been received from the remote management device; and a control unit that causes the first communication unit and the second communication unit to perform a series of communication processing each time the remotely-managed device is booted. The remote management device includes: a third communication unit that receives the predetermined identification information from the remotely-managed device, and transmits the address of the mediation device to the remotely-managed device as a response; and an identifying unit that identifies the address of the mediation device from the predetermined identification information that has been received by the third communication unit. The mediation device includes: a fourth communication unit that receives the information on the remotely-managed device notified by the remotely-managed device

According to another aspect of the present invention, there is provided a remotely-managed device that is remotely managed by a remote management device via a mediation device, the remotely-managed device including: a first communication unit that transmits predetermined identification information to the remote management device, and receives an address of the mediation device as a response; a second communication unit that transmits information on the remotely-managed device to the mediation device using the address of the mediation device that has been received from the remote management device; and a control unit that causes the first communication unit and the second communication unit to perform a series of communication processing each time the remotely-managed device is booted.

According to still another aspect of the present invention, there is provided a mediation device that mediates remote management of a remotely-managed device by a remote management device, the mediation device including: a communication unit that receives information on the remotely-managed device actively notified by the remotely-managed device; and an updating unit that updates information on a device to be monitored on the basis of the information on the remotely-managed device that has been received by the communication unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram showing a configuration of a remote management system according to an embodiment;

FIG. 2 is a block diagram showing a configuration example of a projector;

FIG. 3 is a block diagram showing a configuration example of an image forming apparatus;

FIG. 4 is a block diagram showing a configuration example of a mediation device;

FIG. 5 is a block diagram showing a configuration example of a remote management device;

FIG. 6 is a diagram showing an example of a correspondence table in which a remotely-managed device is associated with a mediation device; and

FIG. 7 is a sequence diagram for explaining a procedure of processing among the devices in the remote management system.

### DETAILED DESCRIPTION OF THE PREFERRED EMBODIMENTS

An exemplary embodiment of a remote management system according to the present invention is explained in detail below with reference to the accompanying drawings. Incidentally, a component common to the drawings is denoted by the same reference numeral.

Remote Management System

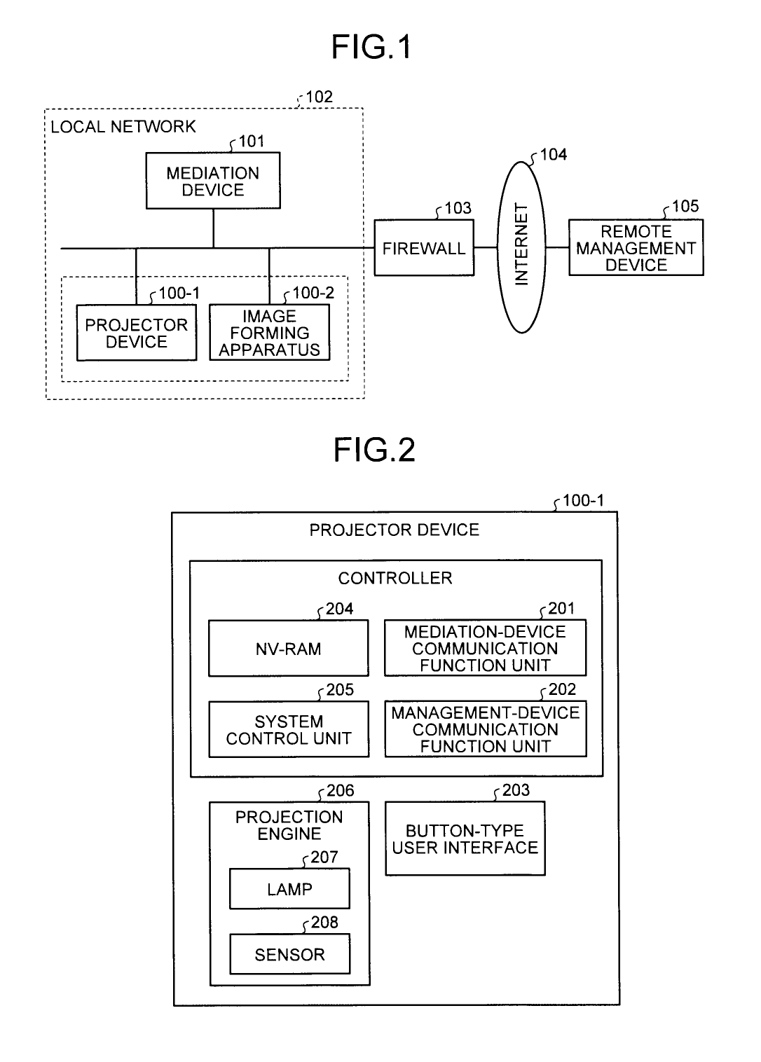

FIG. 1 is a block diagram showing a configuration of the remote management system according to the embodiment.

As shown in FIG. 1, the remote management system includes a plurality of remotely-managed projectors 100-1 and image forming apparatuses 100-2 such as MFPs or printers (in FIG. 1, one of the projectors 100-1 and one of the image forming apparatuses 100-2 are illustrated), a remote-control mediating device (hereinafter, referred to as a “mediation device”) 101 connected to the same local network 102 as the projectors 100-1 and image forming apparatuses 100-2, and a remote management device 105 connected to the mediation device 101 via a firewall 103 and an external network (the Internet in the present embodiment) 104. In this remote management system, the remote management device 105 remotely manages the projectors 100-1 and the image forming apparatuses 100-2 connected to the mediation device 101 on the local network 102 via the Internet 104.

Alternatively, the remote management system can be configured to include a plurality of firewalls 103 and a plurality of remote management devices 105 or to include a plurality of mediation devices 101 in a single firewall 103. Furthermore, an object to be managed by the remote management system is not limited to the projectors 100-1 and/or the image forming apparatuses 100-2, and any devices connected to the local network 102 can be the object to be managed.

Subsequently, details of the devices forming the remote management system are explained.

Projector

FIG. 2 is a block diagram showing a configuration example of the projector 100-1.

As shown in FIG. 2, the projector 100-1 includes a mediation-device communication function unit 201, a management-device communication function unit 202, a button-type user interface 203, a non-volatile random access memory (NV-RAM) 204, a system control unit 205, a projection engine 206, a lamp 207, and a sensor 208.

The mediation-device communication function unit 201 is a communication interface between the mediation device 101 and the projector 100-1. The mediation-device communication function unit 201 receives a request for transmission of a message to the mediation device 101 from the system control unit 205, transmits a message according to the request to the mediation device 101 via the local network 102, and receives a response message to the transmitted message from the mediation device 101. The mediation device 101 is notified of device information of the projector 100-1 (for example, a model and device number of the device as an identifier for identifying the device, a network address of the device, a lamp operating time as status information, and the like).

The management-device communication function unit 202 is a communication interface between the remote management device 105 and the projector 100-1. The management-device communication function unit 202 receives a request for transmission of a message to the remote management device 105 from the system control unit 205, transmits a message according to the request to the remote management device 105 via the firewall 103 and the Internet 104, and receives a response message to the transmitted message from the remote management device 105.

The button-type user interface 203 accepts input from a user, and outputs an accepted request to the system control unit 205. Incidentally, the button-type user interface 203 is used here; alternatively, a user interface with a touch panel and a liquid crystal display panel can be used. With such a user interface, a contract number as identification information (this contract number is determined when a client makes a contract with a remote management service provider) and various setting values can be set.

The NV-RAM 204 is a means for storing execution data, control information, and the like, of the system control unit 205. “NV-RAM” stands for “Non-Volatile RAM”, and is a kind of a nonvolatile storage device.

The system control unit 205 is a means for controlling the units included in the projector 100-1 overall. For example, the system control unit 205 performs control of the booting of the projector 100-1 and control of the projection engine 206, and also requests the communication function unit to transmit a message, and interprets a response message received by each of the communication function units and performs control in accordance with contents of the response message. Furthermore, in response to a request made through the button-type user interface 203, the system control unit 205 performs control according to the request.

The projection engine 206 performs projection of image content under the control by the system control unit 205. The projection engine 206 includes, in addition to the lamp 207, the sensor 208 that detects a lamp operating time. The detection of the lamp operating time by the sensor 208 enables remote management of the life of the lamp 207.

Image Forming Apparatus

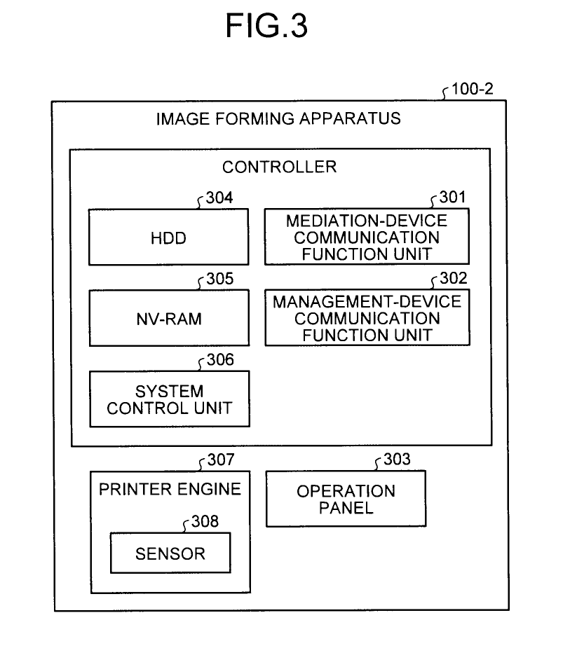

FIG. 3 is a block diagram showing a configuration example of the image forming apparatus 100-2. As shown in FIG. 3, the image forming apparatus 100-2 includes a mediation-device communication function unit 301, a management-device communication function unit 302, an operation panel 303, an HDD 304, an NV-RAM 305, a system control unit 306, a printer engine 307, and a sensor 308. The mediation-device communication function unit 301 and the management-device communication function unit 302 are function units similar to the mediation-device communication function unit 201 and the management-device communication function unit 202 in the projector 100-1, so that description of these units is omitted. However, status information notified to the mediation device 101 by the mediation-device communication function unit 301 of the image forming apparatus 100-2 is information about whether a paper jam, failure, or the like has occurred.

The operation panel 303 is configured by a user interface having a touch panel and a liquid crystal display panel and a button-type user interface, for example. The operation panel 303 accepts input from a user, and outputs an accepted request to the system control unit 306. Furthermore, the operation panel 303 displays a status of the image forming apparatus 100-2 or the like on the liquid crystal display panel in accordance with control by the system control unit 306. Moreover, with the operation panel 303, a contract number as identification information and various setting values can be set.

The HDD 304 and the NV-RAM 305 are means for storing execution data, control information, and the like of the system control unit 306. The HDD 304 is also used as temporary storage of job data having received from a host (not shown) and image data of an image to be actually formed.

The system control unit 306 is a means to integrally control each unit included in the image forming apparatus 100-2. For example, the system control unit 306 performs control of the booting of the image forming apparatus 100-2 and control of the printer engine 307, performs a request to each communication function unit to transmit a message, interprets a response message received by each communication function unit, and performs control in accordance with contents of the response message. Furthermore, in response to a request received through the operation panel 303, the system control unit 306 performs control according to the request.

The printer engine 307 includes a sheet tray unit, a sheet feed unit, a printing unit, a sheet discharge unit, and a sheet discharge tray (all not shown). In printing, as is well known, the printer engine 307 forms an electrostatic latent image on a photoreceptor in accordance with an image signal and a control signal received from the system control unit 306, develops the electrostatic latent image into a toner image, and transfers the toner image onto a transfer sheet fed by the sheet feed unit, and then fixes the toner image on the transfer sheet. Furthermore, the printer engine 307 includes various types of sensors 308, and detects an error in image formation, a feed error, or the like, of the image forming apparatus 100-2 by using the sensors 308. The error detection by the sensors 308 included in the printer engine 307 enables remote management of the image forming apparatus 100-2. Incidentally, the configuration described above can be applied to an MFP having at least any two of a copying function, a printer function, a scanner function, and a facsimile function as well as other image forming apparatuses such as a copying machine, a printer, a facsimile machine, and the like.

Mediation Device

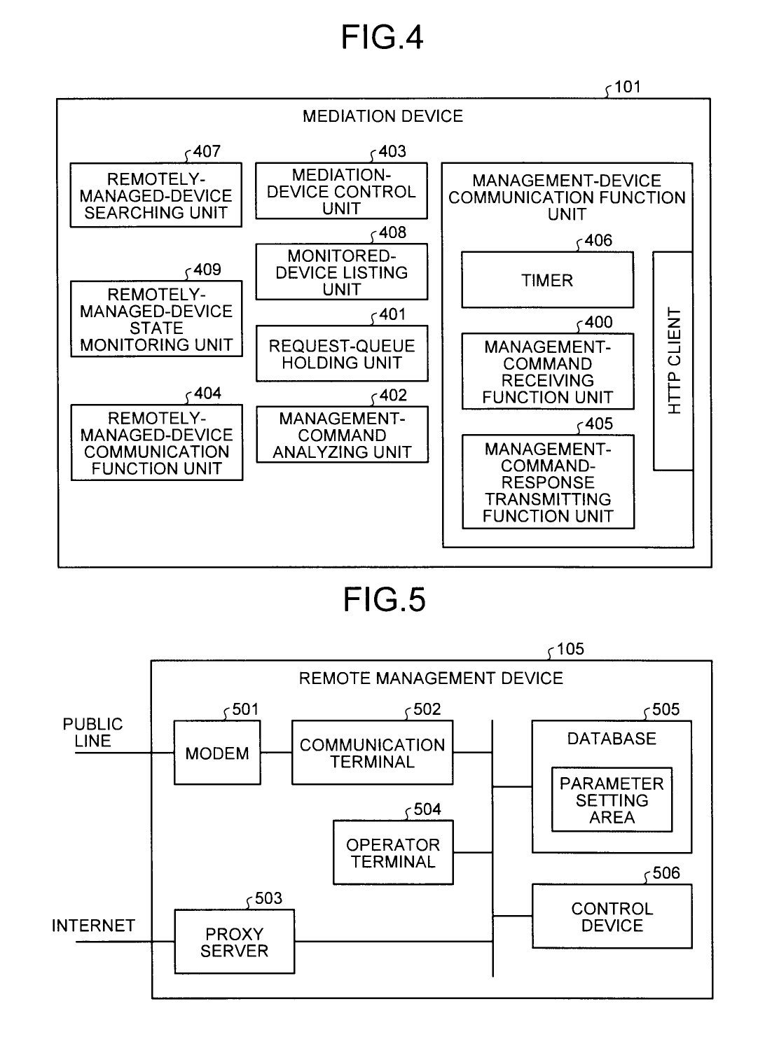

FIG. 4 is a block diagram showing a configuration example of the mediation device 101.

FIG. 4 is a block diagram showing a configuration example of the mediation device 101 in the remote management system. Incidentally, the configuration of the mediation device 101 described below can be applied to, for example, a server computer, or the mediation device 101 can be configured as a dedicated device. In the case where the configuration of the mediation device 101 is applied to the server computer, a management-command receiving function unit 400, a management-command-response transmitting function unit 405, and a remotely-managed-device communication function unit 404 described below are realized by a communication interface included in the server computer; a request-queue holding unit 401 and a monitored-device listing unit 408 are realized by a storage unit, such as an HDD or a memory, included in the server computer; a management-command analyzing unit 402, a mediation-device control unit 403, a remotely-managed-device searching unit 407, and a remotely-managed-device status monitoring unit 409 are realized by a control program included in the server computer and a CPU which executes the control program thereby serving as a control unit of the mediation device 101; a timer 406 is realized by means of a timer included in the server computer.

As shown in FIG. 4, the mediation device 101 includes the management-command receiving function unit 400, the request-queue holding unit 401, the management-command analyzing unit 402, the mediation-device control unit 403, the remotely-managed-device communication function unit 404, the management-command-response transmitting function unit 405, the timer 406, the remotely-managed-device searching unit 407, the monitored-device listing unit 408, and the remotely-managed-device status monitoring unit 409. The management-command receiving function unit 400, the management-command-response transmitting function unit 405, and the timer 406 form a management-device communication function unit in the mediation device 101. Incidentally, in the present embodiment, this management-device communication function unit serves as a Hyper Text Transfer Protocol (HTTP) Client, and the mediation device 101 can establish a direct connection with the remote management device 105 via an HTTP.

The management-command receiving function unit 400 starts a connection to the remote management device 105, and receives a management command transmitted from the remote management device 105 on the basis of the start of the connection. The remotely-managed-device communication function unit 404 receives device information actively transmitted from the projector 100-1 or the image forming apparatus 100-2. The management-command-response transmitting function unit 405 transmits device information corresponding to the management command to the remote management device 105.

The management-command analyzing unit 402 analyzes a management command. The request-queue holding unit 401 holds a management command received by the management-command receiving function unit 400. The mediation-device control unit 403 executes the management command having been analyzed by the management-command analyzing unit 402. Furthermore, the mediation device 101 can be configured to include a device-information storage unit (not shown). The device-information storage unit stores therein device information transmitted from a remotely-managed device. For example, the device-information storage unit stores therein device information that is associated with a management command.

The timer 406 measures a connection start interval. The remotely-managed-device searching unit 407 issues a search command to perform one of acquiring device information of some of the projectors 100-1 or the image forming apparatuses 100-2 and acquiring device information of all the projectors 100-1 or the image forming apparatuses 100-2 upon activation of acquisition by the mediation-device control unit 403, and searches for a remotely-managed device on the local network 102, and then updates the monitored-device listing unit 408 on the basis of a result of the search.

The monitored-device listing unit 408 is formed by an NV-RAM and the like, and stores therein device information of the projectors 100-1 or the image forming apparatuses 100-2, received by the remotely-managed-device communication function unit 404, as the device information for each of the projectors 100-1 and the image forming apparatuses 100-2. The remotely-managed-device status monitoring unit 409 determines whether a status of the projector 100-1 or the image forming apparatus 100-2 identified on the basis of device information stored in the monitored-device listing unit 408 meets a predetermined monitoring condition.

The “device information” here means information on an identifier for identifying the projector 100-1 (for example, a model and device number), a network address, a lamp operating time, and the like, of the projector 100-1, or information on an identifier for identifying the image forming apparatus 100-2, a network address of the image forming apparatus 100-2, and status information of the image forming apparatus 100-2 (for example, whether a paper jam has occurred), and the like. Furthermore, the “monitoring condition” includes, for example, “a lamp operating time: within 2000 hours”, “a device shutdown time in the event of failure: within 10 minutes”, or the like. Namely, when a lamp operating time of the projector 100-1 exceeds 2000 hours or when 10 minutes has elapsed since the image forming apparatus 100-2 has been shut down due to the occurrence of failure, it is determined that the monitoring condition is not satisfied. Moreover, the mediation device 101 includes a CPU that executes processes performed by the units other than the request-queue holding unit 401 and the monitored-device listing unit 408 which are realized on the memory.

In some cases, the management-command receiving function unit 400 receives a plurality of management commands transmitted from the remote management device 105. The plurality of management commands can include one addressed to a remotely-managed device, i.e., the projector 100-1 or the image forming apparatus 100-2 and one addressed to the mediation device 101, or all the management commands can be addressed to either the remotely-managed device or the mediation device 101. Namely, the management-command receiving function unit 400 sometimes receives two management commands, between which one may be addressed to the projector 100-1 or the image forming apparatus 100-2 and the other may be addressed to the mediation device 101. Furthermore, one management command sometimes includes a plurality of identifiers and the like of devices to be managed and sometimes includes a plurality of processing requests.

The management-command receiving function unit 400 starts a connection at a predetermined connection start interval. For example, the connection start interval is preset at five minutes, and the management-command receiving function unit 400 starts a connection to the remote management device 105 at intervals of five minutes by using the timer 406.

The request-queue holding unit 401 is formed by a volatile memory such as a RAM. The request-queue holding unit 401 holds, for example, management commands transmitted from the remote management device 105 in the order in which they have been received by the management-command receiving function unit 400 or by each of the objective devices.

The management-command analyzing unit 402 acquires management commands, for example, in the order in which the management commands have been held in the request-queue holding unit 401, and analyzes the acquired management commands, and then allots the management commands to the mediation-device control unit 403 or the remotely-managed-device communication function unit 404. Or, the management-command analyzing unit 402 preferentially acquires only a management command with respect to a particular objective device out of management commands held in the request-queue holding unit 401 by target device, and allots the acquired management command to the mediation-device control unit 403 or the remotely-managed-device communication function unit 404.

Specifically, for example, when contents of a management command acquired from the request-queue holding unit 401 is a request for two particular image forming apparatuses 100-2 to “set the heater temperature at 50 degrees in centigrade”, the management-command analyzing unit 402 allots the acquired management command regarding the two particular image forming apparatuses 100-2 to the remotely-managed-device communication function unit 404.

Furthermore, to perform this allotment, for example, the management command acquired from the request-queue holding unit 401 is associated with target-device identifiers or the like for identifying the two particular image forming apparatuses 100-2.

The mediation-device control unit 403 executes a management command allotted to the mediation device 101 by the management-command analyzing unit 402. The allotted management command includes, for example, a request to “read out the connection start interval” preset therein. The mediation-device control unit 403 changes the connection start interval. For example, after the elapse of a predetermined period of time, the mediation-device control unit 403 changes the interval of five minutes, which is the preset connection start interval, to, for example, an interval of three minutes (or seven minutes).

The remotely-managed-device status monitoring unit 409 requests the mediation-device control unit 403 to change the connection start interval, for example, when the remotely-managed-device status monitoring unit 409 determines that a status of the projector 100-1 or the image forming apparatus 100-2 identified on the basis of the device information of the remotely-managed devices, i.e., the projectors 100-1 and the image forming apparatuses 100-2, stored in the monitored-device listing unit 408 does not meet a certain monitoring condition. The connection start interval may be changed by this request.

The mediation-device control unit 403 changes the connection start interval by a request from the remote management device 105. For example, it is assumed that the connection start interval is preset at five minutes. By the request from the remote management device 105 to change the connection start interval to three minutes, the mediation-device control unit 403 changes the connection start interval from five minutes to three minutes.

The remotely-managed-device communication function unit 404 transmits, when a management command is addressed to two particular remotely-managed devices, for example, the management command to the two particular remotely-managed devices. The remotely-managed-device communication function unit 404 receives device information, as a response to the management command, from the two particular remotely-managed devices to which the management command has been transmitted.

The management-command-response transmitting function unit 405 transmits a response signal indicating receipt of a management command to the remote management device 105 when the management-command receiving function unit 400 receives the management command from the remote management device 105. The response signal indicating the receipt of the management command to be transmitted to the remote management device 105 is, for example, “accept OK” or the like.

When the management-command-response transmitting function unit 405 receives a response to a management command having been transmitted to the projector 100-1 or the image forming apparatus 100-2 by the remotely-managed-device communication function unit 404, the management-command-response transmitting function unit 405 transmits a response to the received management command to the remote management device 105. For example, with respect to a management command including a request for “setting the heater temperature at 50 degrees in centigrade” on the heater in the image forming apparatus 100-2 from the remote management device 105, a response to the management command to be transmitted to the remote management device 105 is “setting the heater temperature at 50 degrees in centigrade OK”.

Furthermore, for example, the mediation-device control unit 403 periodically starts the monitoring of a remotely-managed device identified on the basis of device information stored in the monitored-device listing unit 408. Here, “periodically” means “at every fixed period of time”. For example, the mediation-device control unit 403 starts the monitoring at an interval of five minutes.

Moreover, for example, when the remotely-managed-device status monitoring unit 409 determines that a status of the image forming apparatus 100-2 does not meet a certain monitoring condition, the mediation-device control unit 403 shortens the initially-set connection start interval for checking a management command to the remote management device 105 from five minutes to three minutes. More specifically, in a case where the monitoring condition is “a device shutdown time in the event of failure: within 10 minutes”, when 10 minutes have passed since the image forming apparatus 100-2 has been shut down due to failure, it is determined that the monitoring condition is not satisfied, and the mediation-device control unit 403 shortens the connection start interval.

The remotely-managed-device communication function unit 404 receives, upon start of acquisition of device information by the mediation-device control unit 403, for example, a device identifier (for example, a model and device number), a network address, and status information of the projector 100-1 or the image forming apparatus 100-2 in an associated manner.

The monitored-device listing unit 408 stores, for example, the device identifier, the network address, and the status information of the projector 100-1 or the image forming apparatus 100-2 received by the remotely-managed-device communication function unit 404 in an associated manner. Namely, the above information is classified for each of the remotely-managed devices and is stored in the monitored-device listing unit 408.

The remotely-managed-device searching unit 407 issues a search command either to acquire device information of some of the remotely-managed devices or to acquire device information of all the remotely-managed devices, searches for a remotely-managed device on the local network 102, and updates the monitored-device listing unit 408 on the basis of a result of the search. For example, let us suppose that there are five remotely-managed devices, which are either the projectors 100-1 or the image forming apparatuses 100-2, connected to the mediation device 101 via the local network 102. Let us also suppose that the identifiers “a1” to “a5”, are assigned to these remotely-managed devices, respectively. Then, the remotely-managed-device searching unit 407 may issue a search command to acquire device information of the two remotely-managed devices having the identifiers “a1” and “a2”.

Remote Management Device

FIG. 5 is a block diagram showing a configuration example of the remote management device 105.

The remote management device 105 is formed by a modem 501, a communication terminal 502, a proxy server 503, an operator terminal 504, a database 505, a control device 506, and the like.

The modem 501 allows the remote management device 105 to establish a communication, via a public line, with the mediation device 101 or a remotely-managed device provided on the side of a device user by modulating data to be transmitted or demodulating received data. The communication terminal 502 controls the communication through the modem 501. The proxy server 503 allows the remote management device 105 to establish a communication with, and performs security management of, the mediation device 101 or the remotely-managed device provided on the side of the device user via the Internet. In this configuration, when a remotely-managed device on the side of the device user is remotely managed via the public line, the remote management device 105 establishes a communication with the remotely-managed device through the modem 501; however, in the present embodiment, because the remote management is performed via the Internet 104 as shown in FIG. 1, the control device 506 makes a communication with a remotely-managed device, which is the projector 100-1 or the image forming apparatus 100-2, via the proxy server 503.

The operator terminal 504 accepts various types of data input by an operator through an operation of an input unit such as a keyboard and a pointing device (a mouse or the like). The operator terminal 504 serves as a confidential-information input unit.

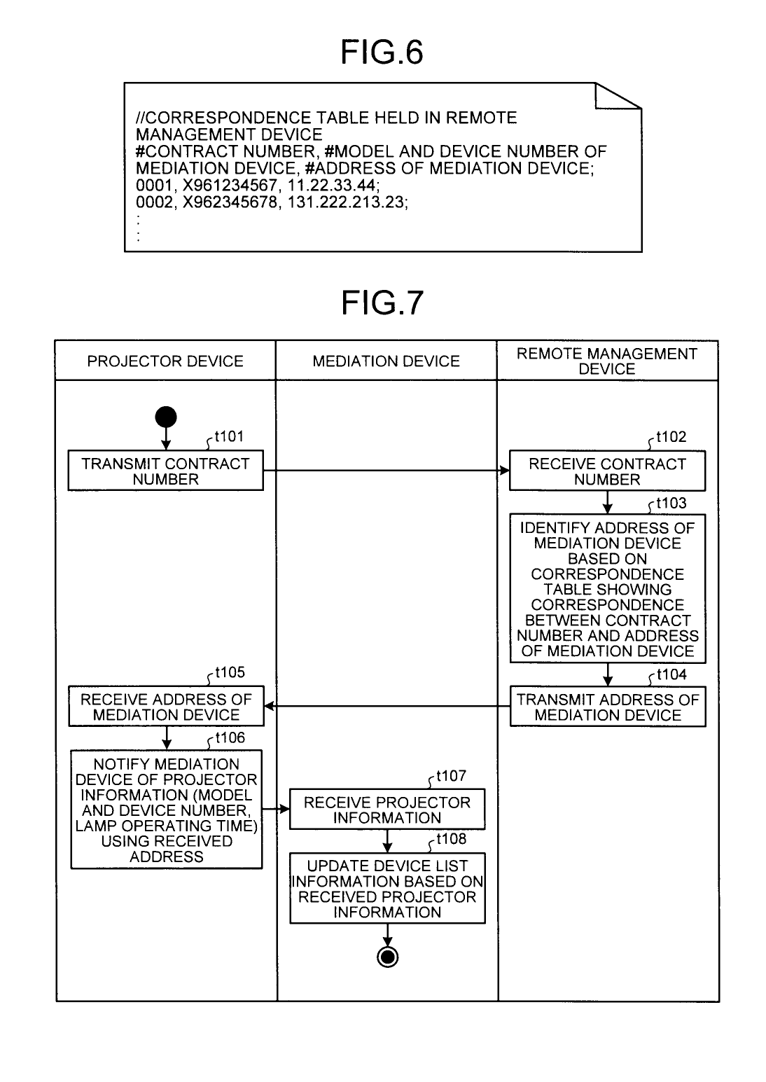

The database 505 is present in a storage device, such as a hard disk drive, of a server (not shown), and stores various types of data, such as data received from the mediation device 101 and remotely-managed devices, which are the projectors 100-1 or the image forming apparatuses 100-2, on the side of the device user and data input through the operator terminal 504. In the storage device, a control program for controlling the remote management device 105 is also stored. The database 505 has a parameter setting area in a predetermined region thereof, and stores various parameters including communication parameters therein. In the present embodiment, the database 505 also stores therein a correspondence table in which a remotely-managed device, which is the projector 100-1 or the image forming apparatus 100-2, is associated with the mediation device 101. This correspondence table is set at the time of setup of the mediation device 101, and held in the database 505. FIG. 6 shows an example of the correspondence table. In this example, a contract number set in a remotely-managed device, a model and device number of a mediation device, and an address of the mediation device are registered in an associated manner.

The control device 506 includes a CPU, a ROM, and a RAM, and the like. (all not shown), and integrally controls the entire remote management device 105. The CPU operates in accordance with the above-described control program and also selectively uses the modem 501, the communication terminal 502, or the proxy server 503 as necessary, thereby realizing the various functions. Furthermore, the control device 506 also serves as an identifying unit for uniquely identifying an address of the mediation device 101 from the correspondence table on the basis of a contract number received from a remotely-managed device.

Here, the communication parameters stored in the parameter setting area of the database 505 are explained. Incidentally, some of the parameters are also stored in a storage unit of the mediation device 101 (or a remotely-managed device).

The communication parameters stored in the parameter setting area of the database 505 and the mediation device 101 (or a remotely-managed device) include network environment information (network environment parameters) which is confidential information on a network environment, such as server information (an IP address of the mediation device 101, a default gateway address, the presence or absence of Dynamic Host Configuration Protocol (DHCP) specification, a subnet mask, a machine name of the Simple Mail Transfer Protocol (SMTP) server, an e-mail address of the remote management device 105, an address and a password of the SMTP server), proxy information (an IP address of a proxy or a proxy address which is a name of the proxy, a proxy authentication key which is an authentication key of the proxy, a hyper text transfer protocol (HTTP) polling mode, a polling interval of the remote management device 105 (in a normal case and an abnormal case)), and PPP information (information on a type of line such as Push Button (PB) or Dial Pulse (DP), the frequency of polling to the remote management device 105 and a polling interval), and managed-object information (managed-object parameters) which is confidential information on an object to be managed, such as an IP address and a model and device number of a remotely-managed device, i.e., the projector 100-1 or the image forming apparatus 100-2. These parameters are to be transmitted from the mediation device 101 to the remote management device 105; the parameters are input to the mediation device 101 or acquired (collected) from a remotely-managed device, i.e., the projector 100-1 or the image forming apparatus 100-2, by the CPU of the mediation device 101, and written in the parameter setting area of the database 505.

The other communication parameters include network environment information, such as a communication path (using a proxy or using a point-to-point protocol (PPP)), an IP address of the remote management device 105, an authentication key or a uniform resource locator (URL) of the mediation device 101, a port number, a time-out period, a periodic notification interval, and if a public line is used, a phone number of the remote management device 105, a phone number of the mediation device 101, a dial-up authentication key in a dial-up connection from the mediation device 101 to the remote management device 105, and a dial-up authentication key in a dial-up connection from the remote management device 105 to the mediation device 101. These parameters are to be transmitted from the remote management device 105 to the mediation device 101; the parameters are stored in the parameter setting area of the database 505 in the remote management device 105 in advance, or input through the operator terminal 504 and written in the parameter setting area of the database 505 by the control device 506.

The mediation-device control unit 403 of the mediation device 101 acquires (collects) managed-object information (confidential parameters on an object to be managed), such as an IP address or a model and device number of a remotely-managed device, i.e., the projector 100-1 or the image forming apparatus 100-2, for example, according to DHCP or SNMP, and writes and sets the acquired (collected) managed-object information in the monitored-device listing unit 408. Furthermore, when network environment information is input by an operator's operation, the mediation-device control unit 403 also writes and sets the network environment information in the monitored-device listing unit 408.

The “DHCP (Dynamic Host Configuration Protocol)” here is a protocol to automatically allocate necessary information, such as an IP address, to a computer which is temporarily connected to the Internet. The “protocol” is a set of mutually-established rules for communication between computers via a network, such as a LAN or the Internet. The “SNMP (Simple Network Management Protocol)” is a protocol to monitor/control a network-connected communication device, such as a router, a computer, or a terminal, in a TCP/IP network via the network.

Processing Procedure

Subsequently, a procedure of processing among the devices in the remote management system configured as described above is explained with reference to FIG. 7. FIG. 7 is a diagram showing an example of the procedure of processing among the devices in the remote management system according to the present embodiment. As an example, the projector 100-1, which is one of the remotely-managed devices, is described below; however, much the same is true on the image forming apparatus 100-2.

When the projector 100-1 is in a state of “ON and connected to the network” while booting the projector 100-1 is referred to as a start state. The start state can be detected by the system control unit 205 of the projector 100-1, and may be detected while the system control unit 205 is in booting control.

When the projector 100-1 falls into the start state, the system control unit 205 of the projector 100-1 transmits a contract number to the remote management device 105 via the management-device communication function unit 202 (t101). The contract number to be transmitted is held, for example, in the NV-RAM 204 of the projector 100-1 in advance. The contract number can be input/set through the button-type user interface 203 or the like, or can be set in the manufacturing process. Furthermore, a URL of the remote management device 105, which is a destination of transmitting the contract number, can also be set in the manufacturing process so that the held URL address can be used in the transmission of the contract number. Incidentally, the contract number is a number based on a contract between a remote management service provider and a client. It is preferable to manage the mediation device 101 and the projector 100-1 on the same client network by assigning the same contract number to them. Here, there is described on the assumption of implementation of management by such assignment of the same contract number.

When receiving the contract number from the projector 100-1 (t102), the remote management device 105 identifies an address (for example, an IP address) of the mediation device 101 from the above-described correspondence table based on the received contract number (t103). Then, the remote management device 105 transmits the identified address of the mediation device 101 to the projector 100-1 (t104).

The above processing can be configured so that the projector 100-1 transmits the contract number as a Simple Object Access Protocol (SOAP) request on an HTTP Secure (HTTPS) request and the remote management device 105 transmits the address of the mediation device 101 to the projector 100-1 as a SOAP response on an HTTPS response. Furthermore, as a means of identifying the address of the mediation device 101, the control device 506 identifies the address of the mediation device 101 connected to the same client network as the projector 100-1 on the basis of the contract number using the above-described correspondence table showing a correspondence between a contract number and an address of a mediation device held in the database 505 in the remote management device 105. By using this correspondence table, an address of the mediation device 101 can be uniquely identified from a contract number. Incidentally, it can be configured that the correspondence table is held in the remote management device 105 and an address of the mediation device 101 is remotely registered in the remote management device 105 via the Internet 104, or it can be configured that an address of the mediation device 101 is input/set to the correspondence table by an operator of the remote management device 105.

Then, upon receiving the address of the mediation device 101 from the remote management device 105 (t105), the projector 100-1 notifies the mediation device 101 of projector information (for example, a model and device number, a lamp operating time, and the like) of the projector 100-1 itself using the address (t106). As for the processes from the receipt of the address of the mediation device 101 to the notification of the projector information of the projector 100-1, the system control unit 205 of the projector 100-1 interprets the address of the mediation device 101 received via the management-device communication function unit 202, and requests the mediation-device communication function unit 201 to notify the mediation device 101 of the projector information of the projector 100-1 using the address as an argument. Furthermore, the system control unit 205 acquires information on a model and device number from the NV-RAM 204, acquires a lamp operating time detected by the sensor 208 from the projection engine 206, and notifies the mediation device 101 of the acquired information as the projector information.

Upon receiving the projector information from the projector 100-1 (t107), the mediation device 101 updates device list information held in the monitored-device listing unit 408 (t108). Concerning a list of projectors, for example, this device list information is made by a model and device number of each projector so as to manage a lamp operating time of the projector. Furthermore, the device list information of image forming apparatuses is made so as to allow the management of the status information on each apparatus such as occurrence of paper jam or a change in a voltage value.

As described above, unlike the conventional technology in which the mediation device 101 actively operates and searches for a remotely-managed device on the local network 102, in the remote management system according to the present embodiment, a remotely-managed device, such as the projector 100-1 or the image forming apparatus 100-2, actively operates, recognizes the mediation device 101 to be managed, and notifies the recognized mediation device 101 of projector information.

Namely, when the remotely-managed device such as the projector 100-1 is in a state of “ON and connected to the network”, the remotely-managed device inquires the remote management device 105 to recognize “a mediation device (a mediation device on the same client network as the projector) by which the remotely-managed device is to be managed”, and notifies the recognized mediation device 101 of projector information on the remotely-managed device; therefore, the mediation device 101 can certainly find even the projector 100-1 having a utilization characteristic that “a network-connection time since power-on is short” from the local network 102.

Furthermore, because the projector 100-1 always operates as a client in a communication to be established, even if an address of a projector is changed, the remote management system according to the present embodiment is unaffected by a change of a projector's address even when the address is changed, and therefore is suitable for a projector having a property of “being carried and used in a variety of places”.

Incidentally, the control program for each device to enable the function of each device in the remote management system according to the present embodiment is built into the NV-RAM or ROM included in each device or another nonvolatile storage medium in advance. Alternatively, the control program can be provided by being recorded on a computer-readable recording medium, such as a CD-ROM, a flexible disk (FD), a CD-R, or a digital versatile disk (DVD), in an installable or executable file format.

Furthermore, the control program can be stored on a computer connected to a network such as the Internet, and the control program can be provided or distributed by being downloaded via the network.

According to the present invention, a mediation device, which is on a local network and works with an external remotely-managed device, can certainly find all remotely-managed devices on the local network, including even a remotely-managed device having a utilization characteristic of a property such as “a short connection time to the network by keeping power ON” or “being carried and used in a variety of places”.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A remote management system comprising:
a remotely-managed device;
a mediation device; and
a remote management device that remotely manages the remotely-managed device via the mediation device, wherein
the remotely-managed device includes:
a first communication unit that transmits predetermined identification information held in the remotely-managed device to the remote management device, and receives an address of the mediation device from the remote management device as a response;
a second communication unit that notifies the mediation device of information on the remotely-managed device using the address of the mediation device that has been received from the remote management device; and
a control unit that causes the first communication unit and the second communication unit to perform a series of communication processing each time the remotely-managed device is booted,
the remote management device includes:
a third communication unit that receives the predetermined identification information from the remotely-managed device, and transmits the address of the mediation device to the remotely-managed device as a response; and
an identifying unit that identifies the address of the mediation device from the predetermined identification information that has been received by the third communication unit, and
the mediation device includes:
a fourth communication unit that receives the information on the remotely-managed device notified by the remotely-managed device.

2. A remotely-managed device that is remotely managed by a remote management device via a mediation device, the remotely-managed device comprising:
a first communication unit that transmits predetermined identification information to the remote management device, and receives an address of the mediation device as a response;
a second communication unit that transmits information on the remotely-managed device to the mediation device using the address of the mediation device that has been received from the remote management device; and
a control unit that causes the first communication unit and the second communication unit to perform a series of communication processing each time the remotely-managed device is booted.

3. The remotely-managed device according to claim 2, further comprising:
an information setting unit that accepts setting of the predetermined identification information; and
an information holding unit that holds the predetermined identification information set by the information setting unit.

4. The remotely-managed device according to claim 2, wherein
the remotely-managed device is a projector, and
the information on the remotely-managed device notified to the mediation device includes a model and device number of the projector and a lamp operating time.

5. A mediation device that mediates remote management of a remotely-managed device by a remote management device, the mediation device comprising:
a communication unit that receives information on the remotely-managed device actively notified by the remotely-managed device; and
an updating unit that updates information on a device to be monitored on the basis of the information on the remotely-managed device that has been received by the communication unit.
